(19) United States
(12) Patent Application Publication
(10) Pub. No.: US 2021/0240350 A1
(43) Pub. Date: Aug. 5, 2021

(54) METHOD, DEVICE, AND COMPUTER PROGRAM PRODUCT FOR RECOVERING BASED ON REVERSE DIFFERENTIAL RECOVERY

(71) Applicant: EMC IP Holding Company LLC, Hopkinton, MA (US)

(72) Inventors: Li Ke, Chengdu (CN); Yizhou Zhou, Chengdu (CN)

(21) Appl. No.: 16/888,822

(22) Filed: May 31, 2020

(30) Foreign Application Priority Data
Feb. 5, 2020 (CN) 202010080364.0

(51) Int. Cl. G06F 3/06

(52) U.S. Cl. CPC G06F 3/065; G06F 3/0673; G06F 3/064; G06F 3/0619

(57) ABSTRACT

This disclosure relates to a recovery method, a device, and a program product based on reverse difference recovery. In a method, a reference mapping of a user system is acquired, the reference mapping comprising a set of digest information about a set of blocks in the user system. Based on an identification of a backup copy for recovering the user system, a copy reference mapping associated with the backup copy is received from a backup storage comprising the backup copy, the copy reference mapping comprising a set of digest information about a set of blocks in the backup copy. A difference between the reference mapping and the copy reference mapping is determined. The user system is recovered to the backup copy based on the determined difference. The user system can be recovered to a designated version more effectively by the above method. A corresponding device and a corresponding computer program product are further provided.

### CROSS-REFERENCE TO RELATED APPLICATIONS

This application claims priority to Chinese Patent Application No. 202010080364.0 filed on Feb. 5, 2020. Chinese Patent Application No. 202010080364.0 is hereby incorporated by reference in its entirety.

### TECHNICAL FIELD

Various implementations of this disclosure relate to data backup and data recovery, and in particular, to a method, a device, and a computer program product based on a reverse difference and used for generating a backup copy for a block in a backup user system and performing data recovery based on the backup copy.

### BACKGROUND

With the development of user systems, many types of user systems have emerged at present. During the use of a user system, the user system may be backed up so that data objects (e.g., including directories and files) in the user system can be recovered to a previous version in the event of a failure of the user system and/or other circumstances. A user and/or an administrator of the user system can select data objects to be backed up, such as files and directories in the user system or the entire user system, to conduct the backup. The data objects in the user system may be classified into a plurality of data blocks, a backup copy is generated based on the plurality of data blocks, and the backup copy is stored in a backup storage (for example, a cluster of storage devices). Further, data objects can be recovered from the backup copy. Recovery efficiency is critical when the user system is in an emergency. Therefore, Recovery Time Objective (RTO) is one of the most important parameters in data protection. The RTO refers to the time taken to recover a normal service procedure in the event of a natural disaster, an emergency, or other situations where data recovery is required.

Image-level or block-level recovery solutions have been proposed in the field of data protection, which typically simply recover all data from the backup storage to the user system. For example, in a PowerProtect data manager, a copy of protected data may be generated in a data domain by a file system backup program, and the copy includes all data blocks of the protected data. A recovery program transmits all copy blocks from the data domain to the user system. If the backup copy is large, it may take an extremely long time for recovery, which will increase the risk of transmission failure and recovery failure. Further, the recovery process will be very expensive in consideration of the cost for transmitting a large amount of data in a hybrid cloud scenario. Therefore, how to reduce recovery time and data transmission volume from the backup storage to the user system more effectively has become a hot topic of research.

### SUMMARY OF THE INVENTION

The invention relates to a technical solution for performing data backup and data recovery more effectively.

According to a first aspect of this disclosure, a method for recovering data in a user system is provided. A reference mapping of the user system is acquired, the reference mapping comprising a set of digest information about a set of blocks in the user system. Based on an identification of a backup copy for recovering the user system, a copy reference mapping associated with the backup copy is received from a backup storage comprising the backup copy, the copy reference mapping comprising a set of digest information about a set of blocks in the backup copy. A difference between the reference mapping and the copy reference mapping is determined. The user system is recovered to the backup copy based on the determined difference.

According to a second aspect of this disclosure, an electronic device is provided, comprising: at least one processor; and a memory coupled to the at least one processor and having instructions stored therein, wherein when executed by the at least one processor, the instructions cause the device to perform actions for recovering data in a user system. The actions comprise: acquiring a reference mapping of the user system, the reference mapping comprising a set of digest information about a set of blocks in the user system; receiving, based on an identification of a backup copy for recovering the user system, a copy reference mapping associated with the backup copy from a backup storage comprising the backup copy, the copy reference mapping comprising a set of digest information about a set of blocks in the backup copy; determining a difference between the reference mapping and the copy reference mapping; and recovering the user system to the backup copy based on the determined difference.

According to a third aspect of this disclosure, a computer program product is provided. The computer program product is tangibly stored in a non-transitory computer-readable medium and comprises machine-executable instructions for performing the method according to the first aspect of this disclosure.

### BRIEF DESCRIPTION OF THE DRAWINGS

The features, advantages, and other aspects of various implementations of this disclosure will become more apparent with reference to accompanying drawings and the following detailed description. Several implementations of this disclosure are illustrated here by way of examples, rather than limitation. In the accompanying drawings:

FIG. 1 schematically shows a block diagram of the architecture of performing backup and recovery operations for a user system according to a technical solution;

FIG. 2 schematically shows a block diagram of a process for performing a recovery operation according to the technical solution shown in FIG. 1;

FIG. 3 schematically shows a block diagram of a process for backing up data and recovering data in a user system according to an example implementation of this disclosure;

FIG. 4 schematically shows a flowchart of a method for recovering data in a user system according to an example implementation of this disclosure;

FIG. 5 schematically shows a block diagram of a mapping relationship between blocks in a user system and digest information in a reference mapping according to an example implementation of this disclosure;

FIG. 6 schematically shows a block diagram of a process for backing up data in a user system according to an example implementation of this disclosure;

FIG. 7 schematically shows a block diagram of a process for recovering data in a user system according to an example implementation of this disclosure;

FIG. 8 schematically shows a block diagram of a process for determining a difference between a reference mapping and a copy reference mapping according to an example implementation of this disclosure;

FIG. 9 schematically shows a block diagram of a process for determining a difference between a reference mapping and a copy reference mapping according to another example implementation of this disclosure; and

FIG. 10 schematically shows a block diagram of a device for managing a user system according to an example implementation of this disclosure.

### DETAILED DESCRIPTION

Preferred implementations of this disclosure will be described in more detail below with reference to the accompanying drawings. The preferred implementations of this disclosure are shown in the accompanying drawings. However, it should be appreciated that this disclosure can be implemented in various forms and should not be limited by the implementations described here. In contrast, the implementations are provided to make this disclosure more thorough and complete, and the scope of this disclosure can be fully conveyed to those skilled in the art.

The term “include/comprise” and variants thereof as used herein indicate open inclusion, i.e., “including/comprising, but not limited to.” Unless specifically stated, the term “or” indicates “and/or.” The term “based on” indicates “based at least in part on.” The terms “an example implementation” and “an implementation” indicate “at least one example implementation.” The term “another implementation” indicates “at least one additional implementation.” The terms “first,” “second,” and the like may refer to different or identical objects. Other explicit and implicit definitions may also be included below.

A variety of user systems have emerged in different application environments. For example, a personal computer may be an example of the user system, and a personal computer may include documents, images, audio, video, and many other types of files. The user system may also include one or more directories, each of which may include another directory and/or one or more files. In the context of this disclosure, files and directories may be referred to as data objects.

In order to ensure the reliability of a personal computer, backup operations may be performed periodically and/or according to a user-specified rule(s). For example, files and directories in the user system, the entire user system, or the like can be backed up. For another example, a file server may be another example of the user system. In this case, the file server may include a plurality of files from one or more users. The user and/or administrator can specify that backup is performed for a certain file and/or some files, or can also be performed for the entire file server.

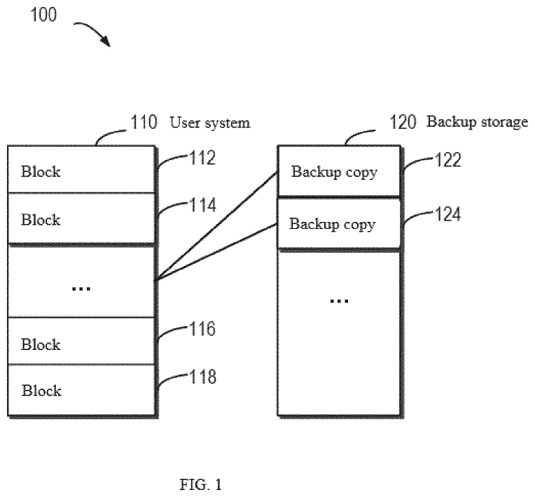

FIG. 1 schematically illustrates block diagram 100 of the architecture of performing backup and recovery operations for user system 110 according to a technical solution. As shown in FIG. 1, user system 110 may include a plurality of blocks 112, 114, . . . , 116, and 118. Data in user system 110 may be divided according to a predetermined size to form the plurality of blocks above. The backup operation can be performed at different time points to generate backup copies of user system 110. The generated backup copies can further be stored in backup storage 120. For example, backup copy 122 may be generated at time point TO, backup copy 124 may be generated at time point T1, and so on.

Various data backup technical solutions have been proposed at present. For example, a full backup requires backing up all blocks in the user system, which will consume a substantial storage resources and bandwidth resources. For another example, incremental backup may only back up blocks in user system 110 that have been changed since the last backup. Although incremental backup reduces the need for storage resources and bandwidth resources, it requires management of a plurality of incremental backup copies strictly in accordance with time. During the recovery operation, reverse recovery operations needs to be performed one by one based on various incremental backup copies in a chronological order from back to forth, so as to recover user system 110 to a desired version.

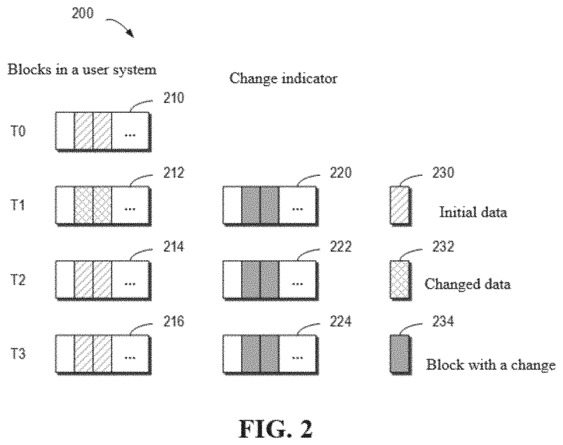

However, performing a reverse recovery operation one by one based on each incremental backup copy may result in a large number of redundant operations, which may lead to inefficient operations of user system 110. In the following, a recovery operation will be described with reference to FIG. 2. FIG. 2 schematically shows block diagram 200 of a process for performing a recovery operation according to the technical solution shown in FIG. 1. As shown on the left side of FIG. 2, states of blocks in user system 110 at different time points are schematically shown. A set of blocks 210 shows the state of user system 110 at time point TO, where each block represents a block in user system 110. A blank block in the state represents an unchanged block, stripe legend 230 shows initial data (for example, the second and third blocks in user system 110).

Data in the second and third blocks in the set of blocks 212 is changed at time point T1 (the changed data is represented by legend 232). In this case, the second and third bits in change indicator 220 are set to shadow legend 234. At time point T2, a set of blocks 214 indicates that the second and third blocks in user system 110 are rolled back to initial data 230. In this case, the second and third bits in change indicator 222 are set to shadow legend 234.

If the data in user system 110 is expected to be recovered to the version at time point T0, even though the data in blocks in user system 110 at time point T2 is exactly the same as the desired version, the recovery operation also needs to be performed on the data in user system 110 twice in the manner of incremental backup. Specifically, starting from user system 110 shown with the set of blocks 214, the data in user system 110 needs to be recovered to that shown in the set of blocks 212 based on an increment between time point T1 and time point T2. Then, the data in user system 110 is recovered to that shown in the set of blocks 210 based on an increment between time point TO and time point T1. It will be understood that although the data in user system 110 is not changed after the two recovery operations, the two recovery operations will result in a large amount of time and computational resource overhead.

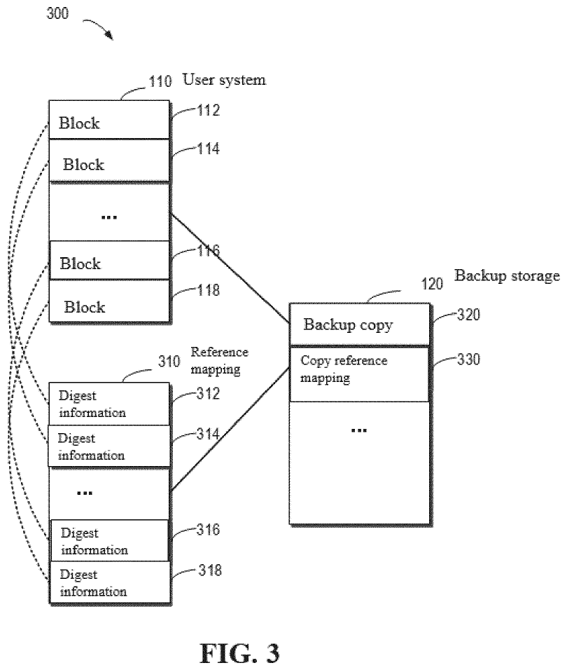

In order to address the above defects, a method for recovering data in user system 110 is provided in an implementation of this disclosure. In the method, the concept of a reference mapping of user system 110 is proposed, and the reference mapping may include a set of digest information about a set of blocks in user system 110. In other words, digest information about a block can uniquely identify data in the block. When a backup operation is performed, the reference mapping of user system 110 can be stored in a backup storage together with a backup copy of user system 110 so as to indicate which blocks are included in the backup copy. In the following, more information about this disclosure will be described with reference to FIG. 3.

FIG. 3 schematically illustrates block diagram 300 of a process for backing up data and recovering data in user system 110 according to an example implementation of this disclosure. As shown in FIG. 3, digest information about each block in user system 110 can be determined during a backup operation. Specifically, digest information 312 can be determined for block 112, digest information 314 can be determined for block 114, digest information 316 can be determined for block 116, digest information 318 can be determined for block 118, and so on. Reference mapping 310 can be generated based on digest information 312 to 318 about the various blocks in user system 110. Then, a copy of reference mapping 310 (that is, copy reference mapping 330) can be stored into backup storage 120 along with backup copy 320 of user system 110.

According to the example implementation of this disclosure, the blocks included in backup copy 320 can be identified by the digest information in copy reference mapping 330. During subsequent recovery operations, a corresponding copy reference mapping can be determined based on an identification of a target version expected to be recovered. Which blocks to be acquired from backup storage 120 can be determined by comparing the reference mapping of current user system 110 with a reference mapping of the target version.

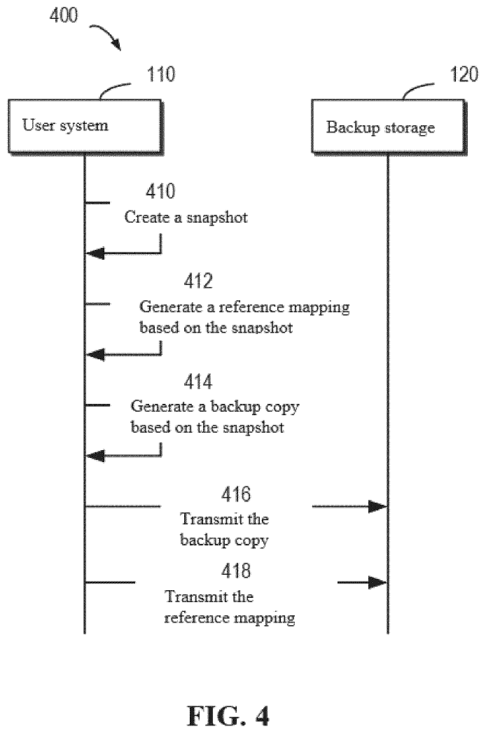

According to the example implementation of this disclosure, it is not necessary to perform the recovery operation based on each backup copy in a backup copy chain, but only necessary to acquire blocks not included in user system 110 from backup storage 120. As such, the bandwidth overhead can be significantly reduced, and the transmission overhead and computation overhead of repeating the recovery operation based on each backup copy in the backup copy chain at user system 110 can be reduced. More details about performing a backup operation will be described below with reference to FIG. 4.

FIG. 4 schematically illustrates block diagram 400 of a process for backing up data in user system 110 according to an example implementation of this disclosure. As shown in FIG. 4, the backup operation can be performed at user system 110, and a generated backup copy and a generated reference mapping are stored in backup storage 120. Specifically, at arrow 410, a snapshot of user system 110 can be created. The purpose of creating a snapshot here is to determine a basis for the backup operation. For example, a snapshot can be created at time point T0. It will be appreciated that content of the snapshot will be fixed and remain unchanged because a range to be transmitted to backup storage 120 is fixed by the snapshot. Content of the backup copy will not be affected even if the data in user system 110 is modified after the snapshot is created. According to the example implementation of this disclosure, a snapshot of user system 110 needs to be created at first regardless of whether full backup or incremental backup is used.

At arrow 412, reference mapping 310 can be generated based on the snapshot. It will be appreciated that the snapshot here may include a set of block snapshots of a set of blocks in user system 110. Therefore, a reference mapping of user system 110 can be acquired based on the set of block snapshots. Specifically, according to the example implementation of this disclosure, a set of digest information about a set of blocks can be acquired respectively based on a set of block snapshots.

Referring back to FIG. 3, digest information about each block can be acquired based on a block snapshot of the block. The digest information about one block can be determined based on a hash algorithm currently known or to be developed in the future. According to the example implementation of this disclosure, the digest information about each block can be uniquely determined based on a secure hash algorithm. For example, digest information can be determined based on an algorithm such as MD5 or SHA. It will be appreciated that the digest information can be stored using different byte lengths, and a corresponding hash algorithm can be selected based on different byte lengths.

According to the example implementation of this disclosure, after the digest information about each block has been acquired, the reference mapping of user system 110 can be generated based on a set of digest information. The digest information about each block can be combined to acquire reference mapping 310. In the example of FIG. 3, digest information 312, 314, . . . , 316, and 318 can be combined to acquire reference mapping 310.

Still referring to FIG. 4, at arrow 414, a backup copy of user system 110 can be generated based on the acquired snapshots. Here, a copy of each block can be generated based on a block snapshot of the block, and a backup copy can be obtained by combining copies of all blocks in user system 110. It will be appreciated that a copy can be generated based on different backup manners. According to the example implementation of this disclosure, a backup copy generated based on full backup will include copies of all blocks in user system 110. Alternatively and/or additionally, a backup copy generated based on incremental backup will include copies of different blocks from the previous backup copy. It will be appreciated that because digest information about all blocks in a backup copy can be described by a reference mapping, a desired backup copy can be acquired in backup storage 120 according to the reference mapping regardless of whether full backup or incremental backup is used.

According to the example implementation of this disclosure, if full backup is used, all the blocks in the snapshots can be transmitted to backup storage 120 so as to form a backup copy. It will be appreciated that full backup needs to be performed when the first backup copy of user system 110 is generated. When a subsequent backup copy of user system 110 is generated, full backup or incremental backup can be performed.

If incremental backup is used, data in user system 110 that has been changed can be determined by comparing a newly created snapshot with a previous snapshot. Specifically, the created new snapshot of user system 110 can include a new set of block snapshots of a set of blocks in user system 110. A new backup copy of user system 110 can be generated incrementally by comparing the new snapshot with the previous snapshot of user system 110 to obtain a difference. The new backup copy can be generated only based on different blocks.

Further, a new reference mapping of user system 110 can be acquired based on a new set of block snapshots. It will be appreciated that the new reference mapping here may include digest information about each block in the new snapshots. On the assumption that the new snapshots include 20 blocks and only the first block is changed, in this case, digest information for the first block in the new reference mapping can be generated based on the changed block, and digest information for the subsequent 19 blocks is the same as the digest information in the reference mapping of the previous version.

According to an example implementation of this disclosure, the new backup copy and the new reference mapping can be stored to backup storage 120 in an associated manner. For example, each reference mapping and each backup copy can be uniquely identified by using an identifier of user system 110 and a timestamp for generating the snapshot. Alternatively and/or additionally, the reference mapping can be uniquely identified by using a version number or other information. Different backup copies of user system 110 can be generated at different time points, and the different backup copies generated can be transmitted to backup storage 120. In this case, each backup copy at backup storage 120 is associated with its own reference mapping, and the reference mapping may include a set of digest information about a set of blocks. Further, corresponding blocks can be acquired based on the digest information.

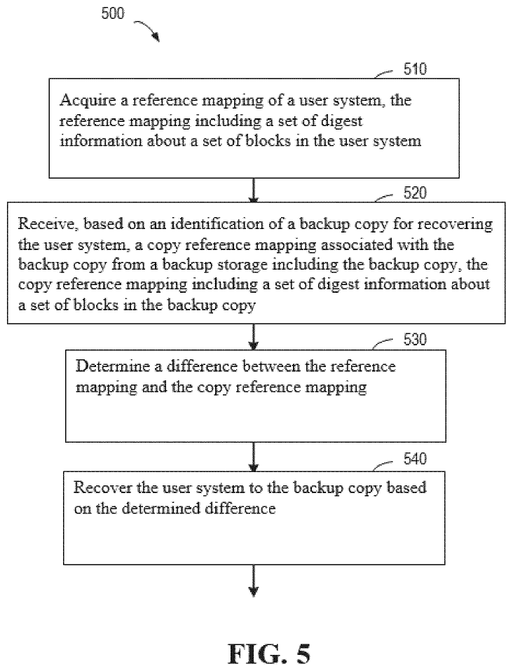

The data in user system 110 can be recovered to a designated version based on the backup copies and reference mapping in backup storage 120. FIG. 5 schematically shows a flowchart of method 500 for recovering data in user system 110 according to an example implementation of this disclosure. In block 510, a reference mapping of user system 110 can be acquired, the reference mapping including a set of digest information about a set of blocks in current user system 110. It will be appreciated that the reference mapping here describes a current state of user system 110. In other words, the reference mapping can indicate which blocks are included in current user system 110.

According to the example implementation of this disclosure, a snapshot of user system 110 can be created to serve as a basis for a recovery operation. Here, the snapshot may include a set of block snapshots of a set of blocks, and a reference mapping of user system 110 can be acquired based on the set of block snapshots. In the recovery operation, the processes of creating a user snapshot and generating a reference mapping are similar to those in the backup operation. Specifically, corresponding digest information can be generated based on each block snapshot. For example, the digest information can be determined based on an algorithm such as MD5 or SHA.

As such, a set of digest information about a set of blocks can be acquired respectively based on a set of block snapshots. Further, the reference mapping of user system 110 can be generated based on the set of digest information. It will be appreciated that an algorithm adopted for generating the digest information here should be the same as the algorithm adopted in the backup stage. For example, digest information about each block can be generated using an MD5 algorithm, and digest information about a plurality of blocks can be combined to form the reference mapping that indicates the current state of user system 110.

It will be appreciated that because the data in user system 110 is usually changed gradually, one or more identical blocks can exist between the current snapshot and the previous snapshot of user system 110. Digest information about the identical blocks will not be changed, and therefore, digest information about unchanged blocks in the previous reference mapping can be reused. Specifically, identical parts and different parts between a set of previous block snapshots in a previous snapshot and the set of block snapshots of user system 110 can be determined, and digest information can be generated only for the different parts.

Specifically, one part (changed part) of the set of digest information is generated based on the part of block snapshots in the set of block snapshots corresponding to the different parts. Further, the other part (unchanged part) of the set of digest information is generated based on the part of digest information corresponding to the identical parts in a set of previous digest information about the set of previous block snapshots. The two parts of digest information can be combined to obtain a final reference mapping.

According to the example implementation of this disclosure, it is not necessary to generate digest information for each block in user system 110, but only necessary to generate digest information for blocks that have been changed. As such, the digest information about unchanged blocks in the previous reference mapping can be reused, thus reducing the time for generating digest information and the overhead of computing resources.

According to the example implementation of this disclosure, digest information may have different granularities. For example, digest information may include a digest of a block in a set of blocks. For another example, digest information may include digests of a plurality of blocks in a set of blocks. It will be appreciated that the blocks here may be basic storage units in user system 110. As such, the state of data in each basic storage unit can be represented accurately. Alternatively and/or additionally, a block may include a plurality of basic storage units, that is, large storage units obtained by division in other manners. According to the example implementation of this disclosure, the state of how many basic storage units is described using digest information can be defined according to the requirements of the user.

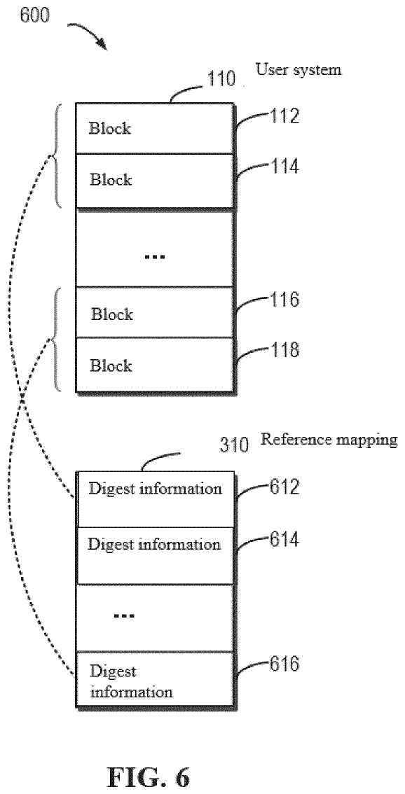

A mapping relationship between blocks and digest information will be described below with reference to FIG. 6. FIG. 6 schematically shows block diagram 600 of a mapping relationship between blocks in user system 110 and digest information in a reference mapping according to an example implementation of this disclosure. As shown in FIG. 6, user system 110 may include blocks 112, 114, . . . , 116, and 118. Digests of two blocks (block 112 and block 114) can be represented by digest information 612, and digests of two blocks (block 116 and block 118) can be represented by digest information 616.

It will be appreciated that if the granularity of the digest information is too fine, it will result in a large amount of digest information and occupy more storage resources. If the granularity of the digest information is too coarse, it will result in a situation where data in a plurality of basic storage units indicated by the digest information needs to be backed up (recovered) even if the data in only one basic storage unit is different, which will consume a lot of processing resources and time overhead. According to the example implementation of this disclosure, the above two aspects can be balanced to perform backup and recovery operations more effectively.

In block 520, based on an identification of a backup copy for recovering user system 110, a copy reference mapping associated with a backup copy can be received from backup storage 120 including the backup copy. Here, the copy reference mapping includes a set of digest information about a set of blocks in the backup copy. It will be appreciated that the copy reference mapping and the backup copy here are generated based on a snapshot of user system 110 created at a previous time point.

In this step, the received copy reference mapping is transmitted to backup storage 120 in the previous backup process. The backup copy can be identified in a variety of manners. For example, when the backup copy is identified with an identifier of user system 110 and a timestamp, two backup copies whose identifiers are “user01-20200101” and “user01-20200110” may exist at backup storage 120. It can be specified that user system 110 is recovered to the backup copy “user01-20200101,” and the copy reference mapping associated with the backup copy can be retrieved from backup storage 120.

In block 530, the reference mapping generated in block 510 and the copy reference mapping retrieved from backup storage 120 in block 520 can be compared and a difference between them can be determined. It will be appreciated that the difference here refers to a difference between the digest information in the two reference mappings. According to the example implementation of this disclosure, a difference between the digest information about each block in the reference mapping and the digest information about each block in the copy reference mapping can be compared one by one so as to determine a difference between the blocks in current user system 110 and in the backup copy serving as a recovery objective.

Specifically, for copy digest information in the set of copy digest information included in the copy reference mapping, digest information corresponding to the copy digest information can be determined in the reference mapping. In other words, the copy digest information in the copy reference mapping can be traversed, and each piece of copy digest information can be compared with each piece of digest information in the reference mapping. Further, a difference can be determined based on the comparison result.

According to the example implementation of this disclosure, on the assumption that the copy reference mapping and the reference mapping both include digest information about 20 blocks and that only the first block of the two backup copies has different digest information, the difference can be determined as the first block in the copy reference mapping. According to the example implementation of this disclosure, it is assumed that the copy reference mapping includes digest information about 20 blocks, the reference mapping includes digest information about 19 blocks, and that the digest information about the 19 blocks in the reference mapping is the same as the digest information about the first 19 blocks in the copy reference mapping. The difference can be determined as the 20th block in the copy reference mapping.

It will be appreciated that only two cases of storage difference are shown schematically above, and more cases may exist according to the example implementation of this disclosure. For example, two reference mappings may involve the same or different number of blocks, and may or may not have an intersection.

In block 540, user system 110 can be recovered to the backup copy based on the determined difference. It will be appreciated that only the block associated with the difference in the backup copy needs to be retrieved from backup storage 120 according to the example implementation of this disclosure. It will be appreciated that the backup copy and the copy reference mapping are stored in backup storage 120 in an associated manner. For example, the backup copy may include a block backup of each block, and the copy reference mapping may include digest information about each block. There may be an association between each block backup and the corresponding digest information. For example, an address of a block copy corresponding to one piece of digest information can be found through the association. In user system 110, a differential block corresponding to a difference can be received from backup storage 120 so as to update a block corresponding to the difference in the set of blocks by using the differential block. As such, the time and bandwidth requirements involved in data transmission can be greatly reduced, and the overhead of processing resources during the recovery can be reduced to improve the overall performance of the recovery operation.

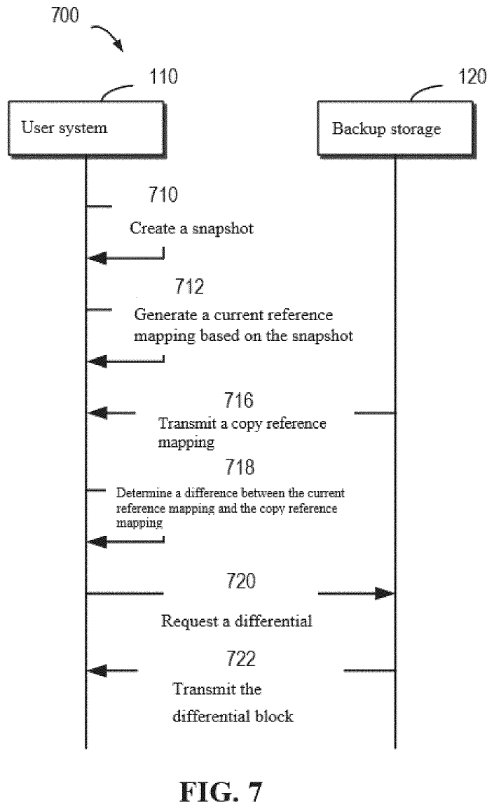

More details about the recovery operation will be described in detail below with reference to FIG. 7. FIG. 7 schematically shows block diagram 700 of a process for recovering data in user system 110 according to an example implementation of this disclosure. As indicated by arrow 710, a snapshot of user system 110 can be created in user system 110. The snapshot here may serve as a basis for a subsequent comparison operation. At arrow 712, a current reference mapping can be generated based on the snapshot. The current reference mapping may include digest information about each block in the created snapshot. For example, the current reference mapping may include digest information about 20 blocks.

As indicated by arrow 716, a copy reference mapping of the target version can be retrieved from backup storage 120. For example, the copy reference mapping may include digest information about 20 blocks. As indicated by arrow 718, a difference between the current reference mapping and the copy reference mapping can be determined. Still referring to the example above, if only the first block is different, as indicated by arrow 720, the first block can be requested to be transmitted from backup storage 120. Then, backup storage 120 may transmit the first block to user system 110. In user system 110, user system 110 can be recovered to a target version by using a copy of the first block received.

In this case, only one block needs to be transmitted from backup storage 120. However, all the 20 blocks need to be transmitted if the recovery operation is performed in the existing full backup manner. Related data of all incremental backups formed between an expected version and the current version needs to be transmitted if the recovery operation is performed in the existing incremental backup manner. Thus, a variety of resources required by data transmission can be greatly reduced according to the example implementation of this disclosure.

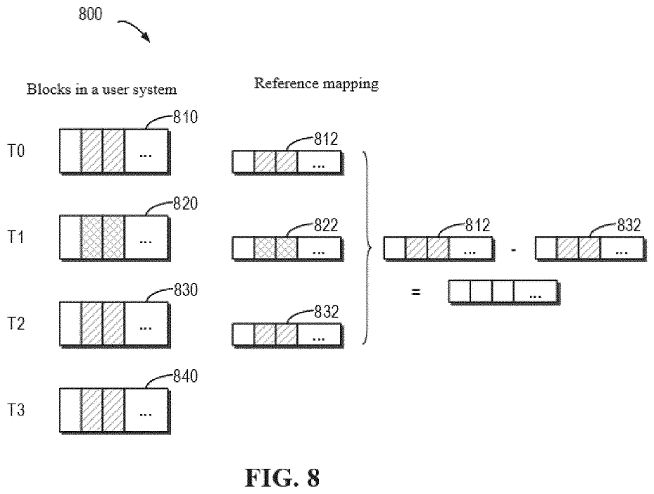

FIG. 8 schematically illustrates block diagram 800 of a process for determining a difference between a reference mapping and a copy reference mapping according to an example implementation of this disclosure. FIG. 8 shows states of a set of blocks in user system 110 from time point T0 to T3 and their reference mappings from time point T0 to T2 respectively. At time point T0, a reference mapping corresponding to a set of blocks 810 is reference mapping 812; at time point T1, a reference mapping corresponding to a set of blocks 820 is reference mapping 822; and at time point T2, a reference mapping corresponding to a set of blocks 830 is reference mapping 832. Backup copies corresponding to time points T0, T1, and T2 respectively can be included in backup storage 120.

At time point T3, the set of blocks 830 is expected to be recovered to the backup copy at time point T0, and reference mapping 812 of the target version can be compared with current reference mapping 832 to determine a difference between them. As shown on the right side of FIG. 8, the two reference mappings are the same and do not have any difference; therefore, no blocks need to be transmitted from backup storage 120 to user system 110. At time point T3, a set of blocks 840 is the target version to which the data is expected to be recovered. However, if the existing technical solution of incremental backup is used, the second block and the third block then need to be transmitted to user system 110 so as to recover user system 110 to the set of blocks 820 at time point T1. Further, the second block and the third block need to be transmitted to user system 110 so as to recover user system 110 to the set of blocks 810 at time point T0. Compared with the above existing technical solution, no blocks need to be transmitted according to the example implementation of this disclosure.

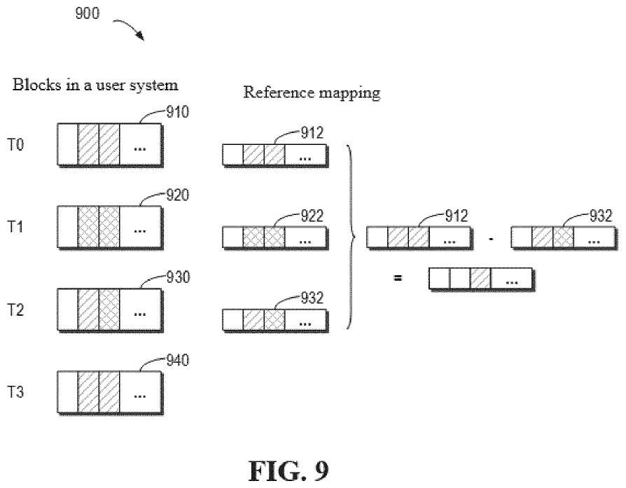

FIG. 9 schematically illustrates block diagram 900 of a process for determining a difference between a reference mapping and a copy reference mapping according to another example implementation of this disclosure. FIG. 9 shows states of a set of blocks in user system 110 from time point T0 to T3 and their reference mappings from time point T0 to T2 respectively. At time point T0, a reference mapping corresponding to a set of blocks 910 is reference mapping 912; at time point T1, a reference mapping corresponding to a set of blocks 920 is reference mapping 922; and at time point T2, a reference mapping corresponding to a set of blocks 930 is reference mapping 932. Backup copies corresponding to time points T0, T1, and T2 respectively can be included in backup storage 120.

At time point T3, the set of blocks 930 is expected to be recovered to the backup copy at time point T0, and reference mapping 912 of the target version can be compared with current reference mapping 932 to determine a difference between them. As shown on the right side of FIG. 9, the difference between the two reference mappings involves only the third block, and therefore, the third block can be transmitted from backup storage 120 to user system 110. At time point T3, user system 110 can be updated to a set of blocks 940 based on the set of blocks 930 and the received third block. Although one block needs to be transmitted in the process shown in FIG. 9, compared with the amount of transmission in the existing technical solution of incremental backup where 4 blocks need to be transmitted, the overhead of network resources and the overhead of time and energy can also be reduced according to the example implementation of this disclosure.

According to the example implementation of this disclosure, more snapshots of user system 110 can further be created. For example, at subsequent time point T4, another snapshot of user system 110 can be created, and the another snapshot includes another set of block snapshots of a set of blocks in user system 110. In order to reduce the workload of generating a backup copy, the another snapshot can be compared with the previous snapshot of user system 110 to obtain a difference, and another backup copy of user system 110 can be generated incrementally. Further, another reference mapping of user system 110 can be acquired based on the other set of block snapshots. It will be appreciated that digest information of unchanged blocks in the previous snapshot can be reused, and digest information only needs to be generated for blocks that have been changed. In the backup operation, another backup copy and another reference mapping can be transmitted to backup storage 120 and can be stored into backup storage 120 in an associated manner.

The example of the method according to this disclosure has been described in detail above with reference to FIG. 2 to FIG. 9, and an implementation of a corresponding apparatus will be described below. According to an example implementation of this disclosure, an apparatus for recovering data in a user system is provided. The apparatus includes: an acquisition module configured to acquire a reference mapping of the user system, the reference mapping including a set of digest information about a set of blocks in the user system; a receiving module configured to receive, based on an identification of a backup copy for recovering the user system, a copy reference mapping associated with the backup copy from a backup storage including the backup copy, the copy reference mapping including a set of digest information about a set of blocks in the backup copy; a determination module configured to determine a difference between the reference mapping and the copy reference mapping; and a recovery module configured to recover the user system to the backup copy based on the determined difference.

According to an example implementation of this disclosure, the acquisition module includes: a creating module configured to create a snapshot of the user system, the snapshot including a set of block snapshots of the set of blocks; and a mapping acquisition module configured to acquire the reference mapping of the user system based on the set of block snapshots.

According to an example implementation of this disclosure, the mapping acquisition module includes: a digest acquisition module configured to acquire the set of digest information about the set of blocks respectively based on the set of block snapshots; and a generation module configured to generate the reference mapping of the user system based on the set of digest information.

According to an example implementation of this disclosure, the digest acquisition module includes: a difference determination module configured to determine identical parts and different parts between a set of previous block snapshots in a previous snapshot and the set of block snapshots of the user system; a first generation module configured to generate one part of the set of digest information based on the part of block snapshots in the set of block snapshots corresponding to the different parts; and a second generation module configured to generate the other part of the set of digest information based on the part of digest information corresponding to the identical parts in a set of previous digest information about the set of previous block snapshots.

According to an example implementation of this disclosure, the difference determination module includes: for copy digest information in the set of copy digest information included in the copy reference mapping, a search module configured to determine digest information corresponding to the copy digest information from the reference mapping; and a comparison module configured to compare the copy digest information with the digest information to determine the difference.

According to an example implementation of this disclosure, digest information in the set of digest information represents at least any one of the following: a digest of a block in the set of blocks; and digests of a plurality of blocks in the set of blocks.

According to an example implementation of this disclosure, the backup copy is generated based on a snapshot of the user system created at a previous time point.

According to an example implementation of this disclosure, the backup copy and the copy reference mapping are stored in the backup storage in an associated manner.

According to an example implementation of this disclosure, the recovery module includes: a receiving module configured to receive a differential block corresponding to the difference from the backup storage; and an updating module configured to update a block corresponding to the difference in the set of blocks by using the differential block.

According to an example implementation of this disclosure, the apparatus further includes: a creating module configured to create another snapshot of the user system, the another snapshot including another set of block snapshots of a set of blocks in the user system; a comparison module configured to compare the another snapshot with the previous snapshot of the user system to obtain a difference, and generate another backup copy of the user system incrementally; a reference mapping acquisition module configured to acquire another reference mapping of the user system based on the another set of block snapshots; and a storage module configured to store the another backup copy and the another reference mapping in the backup storage in an associated manner.

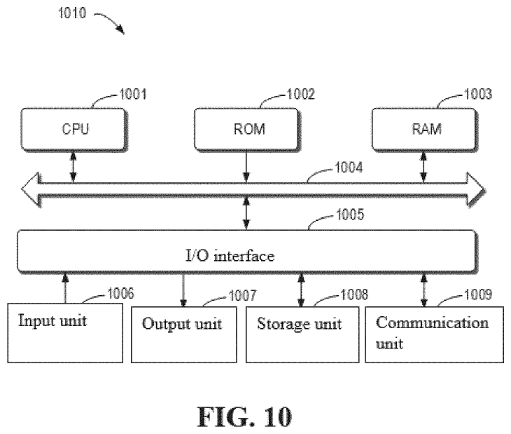

FIG. 10 schematically illustrates a block diagram of device 1000 for managing a user system according to an example implementation of this disclosure. As shown in the figure, device 1000 includes central processing unit (CPU) 1001 that can perform various appropriate actions and processing according to computer program instructions stored in read-only memory (ROM) 1002 or computer program instructions loaded from storage unit 1008 to random access memory (RAM) 1003. Various programs and data required for the operation of device 1000 can also be stored in RAM 1003. CPU 1001, ROM 1002, and RAM 1003 are connected to each other through bus 1004. Input/output (I/O) interface 1005 is also connected to bus 1004.

A plurality of components in device 1000 are connected to I/O interface 1005, including: input unit 1006, such as a keyboard and a mouse; output unit 1007, such as various types of displays and speakers; storage unit 1008, such as a magnetic disk and an optical disc; and communication unit 1009, such as a network card, a modem, and a wireless communication transceiver. Communication unit 1009 allows device 1000 to exchange information/data with other devices over a computer network such as the Internet and/or various telecommunication networks.

The various processes and processing described above, for example, method 500, may be performed by processing unit 1001. For example, in some implementations, method 500 can be implemented as a computer software program that is tangibly included in a machine-readable medium such as storage unit 1008. In some implementations, some or all of the computer program can be loaded and/or installed onto device 1000 via ROM 1002 and/or communication unit 1009. When the computer program is loaded into RAM 1003 and executed by CPU 1001, one or more steps of method 500 described above may be implemented. Alternatively, in other implementations, CPU 1001 can also be configured in any other suitable manner to implement the processes/methods described above.

According to an example implementation of this disclosure, an electronic device is provided, including: at least one processor; and a memory coupled to the at least one processor and having instructions stored therein, wherein when executed by the at least one processor, the instructions cause the device to perform actions for recovering data in a user system. The actions include: acquiring a reference mapping of the user system, the reference mapping including a set of digest information about a set of blocks in the user system; receiving, based on an identification of a backup copy for recovering the user system, a copy reference mapping associated with the backup copy from a backup storage including the backup copy, the copy reference mapping including a set of digest information about a set of blocks in the backup copy; determining a difference between the reference mapping and the copy reference mapping; and recovering the user system to the backup copy based on the determined difference.

According to an example implementation of this disclosure, acquiring the reference mapping of the user system includes: creating a snapshot of the user system, the snapshot including a set of block snapshots of the set of blocks; and acquiring the reference mapping of the user system based on the set of block snapshots.

According to an example implementation of this disclosure, acquiring the reference mapping of the user system based on the set of block snapshots includes: acquiring the set of digest information about the set of blocks respectively based on the set of block snapshots; and generating the reference mapping of the user system based on the set of digest information.

According to an example implementation of this disclosure, acquiring the set of digest information about the set of blocks respectively based on the set of block snapshots includes: determining identical parts and different parts between a set of previous block snapshots in a previous snapshot and the set of block snapshots of the user system; generating one part of the set of digest information based on the part of block snapshots in the set of block snapshots corresponding to the different parts; and generating the other part of the set of digest information based on the part of digest information corresponding to the identical parts in a set of previous digest information about the set of previous block snapshots.

According to an example implementation of this disclosure, determining the difference between the reference mapping and the copy reference mapping includes: for copy digest information in the set of copy digest information included in the copy reference mapping, determining digest information corresponding to the copy digest information from the reference mapping; and comparing the copy digest information with the digest information to determine the difference.

According to an example implementation of this disclosure, digest information in the set of digest information represents at least any one of the following: a digest of a block in the set of blocks; and digests of a plurality of blocks in the set of blocks.

According to an example implementation of this disclosure, the backup copy is generated based on a snapshot of the user system created at a previous time point.

According to an example implementation of this disclosure, the backup copy and the copy reference mapping are stored in the backup storage in an associated manner.

According to an example implementation of this disclosure, recovering the user system to the backup copy based on the determined difference includes: receiving a differential block corresponding to the difference from the backup storage; and updating a block corresponding to the difference in the set of blocks by using the differential block.

According to an example implementation of this disclosure, the actions further include: creating another snapshot of the user system, the another snapshot including another set of block snapshots of a set of blocks in the user system; comparing the another snapshot with the previous snapshot of the user system to obtain a difference, and generating another backup copy of the user system incrementally; acquiring another reference mapping of the user system based on the another set of block snapshots; and storing the another backup copy and the another reference mapping in the backup storage in an associated manner.

According to an example implementation of this disclosure, a computer program product is provided. The computer program product is tangibly stored in a non-transitory computer-readable medium and includes machine-executable instructions for performing the method according to this disclosure.

According to an exemplary implementation of this disclosure, a computer-readable medium is provided. Machine-executable instructions are stored on the computer-readable medium, and when executed by at least one processor, the machine-executable instructions cause the at least one processor to implement the method according to this disclosure.

This disclosure may be a method, a device, a system, and/or a computer program product. The computer program product may include a computer-readable storage medium having computer-readable program instructions for performing various aspects of this disclosure loaded thereon.

The computer-readable storage medium can be a tangible device capable of retaining and storing instructions used by an instruction-executing device. For example, the computer-readable storage medium can be, but is not limited to, an electrical storage device, a magnetic storage device, an optical storage device, an electromagnetic storage device, a semiconductor storage device, or any appropriate combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical coding device such as a punch card or a protruding structure within a groove on which instructions are stored, and any appropriate combination of the above. The computer-readable storage medium as used herein is not explained as transient signals per se, such as radio waves or other electromagnetic waves propagated freely, electromagnetic waves propagated through waveguides or other transmission media (e.g., optical pulses propagated through fiber-optic cables), or electrical signals transmitted over electrical wires.

The computer-readable program instructions described here may be downloaded from the computer-readable storage medium to various computing/processing devices or downloaded to external computers or external storage devices over a network such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of this disclosure may be assembly instructions, instruction set architecture (ISA) instructions, machine instructions, machine-related instructions, microcode, firmware instructions, state setting data, or source code or object code written in any combination of one or more programming languages, including object-oriented programming languages such as Smalltalk, C++, etc., as well as conventional procedural programming languages such as the “C” language or similar programming languages. The computer-readable program instructions can be completely executed on a user's computer, partially executed on a user's computer, executed as a separate software package, partially executed on a user's computer and partially executed on a remote computer, or completely executed on a remote computer or a server. In the case where a remote computer is involved, the remote computer can be connected to a user's computer over any kind of networks, including a local area network (LAN) or a wide area network (WAN), or can be connected to an external computer (e.g., connected over the Internet using an Internet service provider). In some implementations, an electronic circuit, such as a programmable logic circuit, a field programmable gate array (FPGA), or a programmable logic array (PLA), can be customized by utilizing state information of the computer-readable program instructions. The electronic circuit may execute the computer-readable program instructions to implement various aspects of this disclosure.

Various aspects of this disclosure are described here with reference to flowcharts and/or block diagrams of the method, the apparatus (system), and the computer program product implemented according to this disclosure. It should be appreciated that each block in the flowcharts and/or block diagrams and a combination of blocks in the flowcharts and/or block diagrams can be implemented by computer-readable program instructions.

The computer-readable program instructions can be provided to a processing unit of a general purpose computer, a special purpose computer, or another programmable data processing apparatus to produce a machine such that the instructions, when executed by the processing unit of the computer or another programmable data processing apparatus, generate an apparatus for implementing the functions/actions specified in one or more blocks in the flowcharts and/or block diagrams. These computer-readable program instructions may also be stored in a computer-readable storage medium, and these instructions cause a computer, a programmable data processing apparatus and/or other devices to work in a specific manner, such that the computer-readable medium storing the instructions includes an article of manufacture including instructions for implementing various aspects of the functions/actions specified in one or more blocks of the flowcharts and/or block diagrams.

The computer-readable program instructions may also be loaded into a computer, another programmable data processing apparatus, or another device such that a series of operational steps are performed on the computer, another programmable data processing apparatus, or another device to produce a computer-implemented process. As such, the instructions executed on the computer, another programmable data processing apparatus, or another device implement the functions/actions specified in one or more blocks of the flowcharts and/or block diagrams.

The flowcharts and block diagrams in the accompanying drawings illustrate the architecture, functions, and operations of possible implementations of systems, methods, and computer program products according to multiple implementations of this disclosure. In this regard, each block in the flowcharts or block diagrams can represent a module, a program segment, or a portion of an instruction that includes one or more executable instructions for implementing the specified logical functions. In some alternative implementations, functions labeled in the blocks may also occur in an order different from that labeled in the accompanying drawings. For example, two successive blocks may actually be performed basically in parallel, or sometimes they can be performed in an opposite order, depending on the functions involved. It also should be noted that each block in the block diagrams and/or flowcharts and a combination of blocks in the block diagrams and/or flowcharts can be implemented using a dedicated hardware-based system for executing specified functions or actions, or can be implemented using a combination of dedicated hardware and computer instructions.

Various implementations of this disclosure have been described above, and the foregoing description is illustrative rather than exhaustive, and is not limited to the various implementations disclosed. Numerous modifications and changes are apparent to those of ordinary skill in the art without departing from the scope and spirit of the various implementations illustrated. The selection of terms as used herein is intended to best explain the principles and practical applications of the various implementations, or the technical improvements to technologies on the market, or to enable other persons of ordinary skill in the art to understand the various implementations disclosed here.

1. A method for recovering data in a user system, comprising:
acquiring a reference mapping of the user system, the reference mapping comprising a set of digest information about a set of blocks in the user system;
receiving, based on an identification of a backup copy for recovering the user system, a copy reference mapping associated with the backup copy from a backup storage comprising the backup copy, the copy reference mapping comprising a set of digest information about a set of blocks in the backup copy;
determining a difference between the reference mapping and the copy reference mapping; and
recovering the user system to the backup copy based on the determined difference.

2. The method of claim 1, wherein acquiring the reference mapping of the user system comprises:
creating a snapshot of the user system, the snapshot comprising a set of block snapshots of the set of blocks; and
acquiring the reference mapping of the user system based on the set of block snapshots.

3. The method of claim 2, wherein acquiring the reference mapping of the user system based on the set of block snapshots comprises:
acquiring the set of digest information about the set of blocks respectively based on the set of block snapshots; and
generating the reference mapping of the user system based on the set of digest information.

4. The method of claim 3, wherein acquiring the set of digest information about the set of blocks respectively based on the set of block snapshots comprises:
determining identical parts and different parts between a set of previous block snapshots in a previous snapshot and the set of block snapshots of the user system;
generating one part of the set of digest information based on the part of block snapshots in the set of block snapshots corresponding to the different parts; and
generating another part of the set of digest information based on the part of digest information corresponding to the identical parts in a set of previous digest information about the set of previous block snapshots.

5. The method of claim 1, wherein determining the difference between the reference mapping and the copy reference mapping comprises:
determining digest information from the reference mapping corresponding to digest information from the copy reference mapping; and
comparing the copy digest information with the digest information to determine the difference.

6. The method of claim 1, wherein digest information in the set of digest information represents at least one of the following:
a digest of a block in the set of blocks; and
digests of a plurality of blocks in the set of blocks.

7. The method of claim 1, wherein the backup copy is generated based on a snapshot of the user system created at a previous time point.

8. The method of claim 1, wherein the backup copy and the copy reference mapping are stored in the backup storage in an associated manner.

9. The method of claim 1, wherein recovering the user system to the backup copy based on the determined difference comprises:
receiving a differential block corresponding to the difference from the backup storage; and
updating a block corresponding to the difference in the set of blocks by using the differential block.

10. The method of claim 1, further comprising:
creating another snapshot of the user system, the another snapshot comprising another set of block snapshots of a set of blocks in the user system;
comparing the another snapshot with a previous snapshot of the user system to obtain a difference, and generating another backup copy of the user system incrementally;
acquiring another reference mapping of the user system based on the another set of block snapshots; and
storing the another backup copy and the another reference mapping in the backup storage in an associated manner.

11. An electronic device, comprising:
at least one processor; and
a memory coupled to the at least one processor and having instructions stored therein, wherein when executed by the at least one processor, the instructions cause the electronic device to perform a method for recovering data in a user system, the method comprising:
acquiring a reference mapping of the user system, the reference mapping comprising a set of digest information about a set of blocks in the user system;
receiving, based on an identification of a backup copy for recovering the user system, a copy reference mapping associated with the backup copy from a backup storage comprising the backup copy, the copy reference mapping comprising a set of digest information about a set of blocks in the backup copy;
determining a difference between the reference mapping and the copy reference mapping; and
recovering the user system to the backup copy based on the determined difference.

12. The electronic device of claim 11, wherein acquiring the reference mapping of the user system comprises:
creating a snapshot of the user system, the snapshot comprising a set of block snapshots of the set of blocks; and
acquiring the reference mapping of the user system based on the set of block snapshots.

13. The electronic device of claim 12, wherein acquiring the reference mapping of the user system based on the set of block snapshots comprises:
acquiring the set of digest information about the set of blocks respectively based on the set of block snapshots; and
generating the reference mapping of the user system based on the set of digest information.

14. The electronic device of claim 13, wherein acquiring the set of digest information about the set of blocks respectively based on the set of block snapshots comprises:
determining identical parts and different parts between a set of previous block snapshots in a previous snapshot and the set of block snapshots of the user system;
generating one part of the set of digest information based on the part of block snapshots in the set of block snapshots corresponding to the different parts; and
generating another part of the set of digest information based on the part of digest information corresponding to the identical parts in a set of previous digest information about the set of previous block snapshots.

15. The electronic device of claim 11, wherein determining the difference between the reference mapping and the copy reference mapping comprises:
determining digest information from the reference mapping corresponding to digest information from the copy reference mapping; and
comparing the copy digest information with the digest information to determine the difference.

16. The electronic device of claim 11, wherein digest information in the set of digest information represents at least one of the following:
a digest of a block in the set of blocks; and
digests of a plurality of blocks in the set of blocks.

17. The electronic device of claim 11, wherein the backup copy is generated based on a snapshot of the user system created at a previous time point.

18. The electronic device of claim 11, wherein the backup copy and the copy reference mapping are stored in the backup storage in an associated manner.

19. The electronic device of claim 11, wherein recovering the user system to the backup copy based on the determined difference comprises:
receiving a differential block corresponding to the difference from the backup storage; and
updating a block corresponding to the difference in the set of blocks by using the differential block.

20. A computer program product tangibly stored in a non-transitory computer-readable medium and comprising machine-executable instructions for performing a method, the method comprising:
acquiring a reference mapping of the user system, the reference mapping comprising a set of digest information about a set of blocks in the user system;
receiving, based on an identification of a backup copy for recovering the user system, a copy reference mapping associated with the backup copy from a backup storage comprising the backup copy, the copy reference mapping comprising a set of digest information about a set of blocks in the backup copy;
determining a difference between the reference mapping and the copy reference mapping; and
recovering the user system to the backup copy based on the determined difference.
